(19) United States
(12) Patent Application Publication
(10) Pub. No.: US 2014/0368652 A1
(43) Pub. Date: Dec. 18, 2014

(54) METHODS AND SYSTEMS FOR EFFICIENTLY MONITORING PARKING OCCUPANCY

(71) Applicant: XEROX CORPORATION, NORWALK, CT (US)

(72) Inventor: Yao Rong Wang, Webster, NY (US)

(21) Appl. No.: 13/920,361

(22) Filed: Jun. 18, 2013

(51) Int. Cl. G06K 9/00

(52) U.S. Cl. CPC G06K 9/00812
USPC 348/148

(57) ABSTRACT

A system and method for determining parking occupancy and maintaining a database of parking occupancy data by receiving video data for a parking area from multiple video cameras, determining parking occupancy data for the parking area using the video data for the parking area, generating textual data corresponding to the parking occupancy data for the parking area, and transmitting the textual data corresponding to the parking occupancy data for the parking area to a central server. The central server can receive textual data from multiple devices and maintain and update a database of parking occupancy data based on the textual data received.

### TECHNICAL FIELD

The present disclosure relates generally to methods, systems, and computer-readable media for a parking monitoring network.

### BACKGROUND

Determining and providing real-time parking occupancy data over a large area, such as a city, can effectively reduce fuel consumption and traffic congestion, while allowing area authorities to efficiently monitor and detect parking violations and provide automated parking payment options.

Current systems can process video data to determine real-time parking occupancy. However, efficiently processing the video data can create implementation issues that can lead to inefficiency and/or high costs. For example, receiving a large amount of video data at one location can create bandwidth issues, and individually processing video data at each camera can be prohibitively expensive.

Therefore, parking monitoring systems be improved by methods and systems for using an efficiently structured parking monitoring network.

### SUMMARY

The present disclosure relates generally to methods, systems, and computer readable media for providing these and other improvements to parking monitoring systems.

In some embodiments, a computing device can receive video data from multiple video cameras. Using the video data, the computing device can determine parking occupancy data for the parking area captured in the video data. The computing device can generate textual data representing the parking occupancy data and transmit the textual data to a central server.

In further embodiments, a central server can receive textual data representing parking occupancy data from multiple computing devices, where each computing device generated the textual data based on video data from multiple cameras. The central sever can process the textual data to update and maintain a database of parking occupancy data, and can respond to requests for parking occupancy status information over the large area.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a flow diagraming illustrating an exemplary method of determining parking occupancy, consistent with certain disclosed embodiments;

FIG. 2 is a diagram depicting an exemplary video camera arrangement for determining parking occupancy of a parking area, consistent with certain disclosed embodiments;

FIG. 3 is a diagram depicting an exemplary parking monitoring network, consistent with certain disclosed embodiments;

FIG. 4 is a diagram depicting an exemplary parking monitoring network, consistent with certain disclosed embodiments; and

FIG. 5 is a diagram illustrating an exemplary hardware system for deter mining parking occupancy, consistent with certain disclosed embodiments.

### DETAILED DESCRIPTION

The following detailed description refers to the accompanying drawings. Wherever possible, the same reference numbers are used in the drawings and the following description refers to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

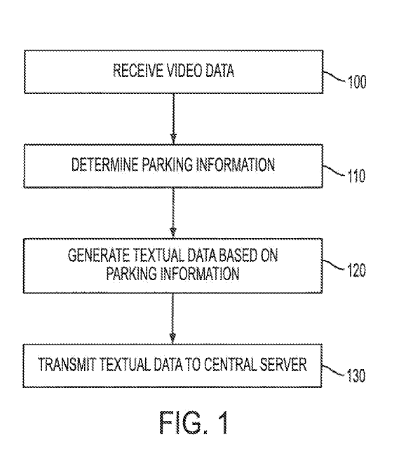

FIG. 1 is a flow diagraming illustrating an exemplary method of determining parking occupancy, consistent with certain disclosed embodiments. The process can begin in 100 when a computing device receives video data from multiple video cameras. In embodiments, the video data can be streaming video feeds from the multiple video cameras. In further embodiments, the video data can be recorded videos from the multiple video cameras.

In some implementations, the video data can represent captured video of a particular parking area. For example, the video cameras can be strategically positioned to capture various angles and/or perspectives of the particular parking area to create a wide viewing area and/or avoid occlusion factors.

In 110, the computing device can determine parking occupancy data based on the video data from the video cameras. For example, the computing device can determine parking occupancy data for the particular parking area using captured video from the multiple video cameras.

The computing device can use various methods for determining parking occupancy data based on video data. For example, the computing device can use the methods described in: U.S. patent application Ser. No. 13/441,269, filed Apr. 6, 2012; U.S. patent application Ser. No. 13/836,310, filed Mar. 15, 2013; and/or U.S. patent application Ser. No. 13/461,191, filed May 1, 2013. All three U.S. patent applications referenced above are incorporated herein by reference in their entirety, and, as of the filing date of this application, all three U.S. patent applications are commonly assigned to Xerox® Corporation. Such methods described above can be used, for example, to estimate available on-street parking spaces, to identify vehicles for parking violations, to classify parking spaces as occupied or not occupied, to train parking space classifiers, etc.

In 120, the computing device can generate textual data based on the parking occupancy data. In embodiments, the computing device can generate textual data, such as or including a character string, that represents parking occupancy data of parking spaces within the particular parking area. For example, the character string can include representations of all the potential spaces within the particular parking area, as well as an occupancy status of each potential space (e.g. occupied or not occupied). In further embodiments, the character string can also include additional information, such as a total number of available spaces in a parking area, vehicle identifications, parking violation detections, etc.

Below is an example of possible textual data that can be generated by the computing device:
North Spaces=6; Available North Spaces=2; South Spaces=6; Available South Spaces=0.

The above textual data can be generated based on the following determinations made using video data of a street with street parking: the north side of the street includes six parking spaces, and two of the parking spaces are currently available; the south side of the street includes six parking spaces, and none of the parking spaces are currently available.

The above textual data is merely for the purpose of illustration and is not intended to be limiting. In embodiments, the textual data generated by the computing device can be in various formats and can include more information or less information. For example, specific parking space occupancy status information, vehicle identification information, parking violation information, and other information can be included as part of the textual data. As an additional example, the textual data may not separate a parking area into segments (e.g. a north and south side) and can provide a total number of parking spaces available for the whole parking area as a single number.

Further, while the above example depicts textual data corresponding to parking occupancy for street parking, embodiments can be utilized for other parking area types, such as in parking lots. Additionally, identification labels (e.g. North Spaces) are used in the above example for the purpose of illustration and are not required to be part of the textual data generated by the computing device.

In 130, the computing device can transmit the textual data to a central server. In embodiments, the central server can receive textual data from multiple computing devices, and each computing device can be connected to and receive video data from one or more video cameras. Additionally, in further embodiments, each computing device can monitor occupancy for a specific parking area based on the positioning of the video cameras connected to each computing device. Accordingly, each set of textual data received by the central server can represent a specific parking area.

The central server can parse the textual data received from each computing device to determine the parking occupancy data represented therein. Based on the multiple sets of textual data, the central server can aggregate parking occupancy data over a larger area than the particular parking area monitored by the computing device described above. Further, the central server can store and distribute the parking occupancy data as needed. For example, the central server can maintain a database of parking occupancy data and continuously update the database when new textual data is received from a computing device.

Additionally, the central server can respond to requests for parking occupancy data for a requested parking area. For example, a user may request parking occupancy data for a specified parking area within a city using an application on a mobile device. The central server can receive the request and respond with appropriate information.

Moreover, in some embodiments, the central server can generate parking occupancy reports using the database of parking occupancy data. Further, in other embodiments, the central server can manage parking space payments and/or can alert appropriate authorities when a parking violation is detected. For example, the central server can receive and process a payment corresponding to a parking space from a user via a mobile device and/or alert parking authorities when a parking space is determined to be occupied and no payment was received.

While the steps depicted in FIG. 1 have been described as performed in a particular order, the order described is merely exemplary, and various different sequences of steps can be performed, consistent with certain disclosed embodiments. Additional variations of steps can be utilized, consistent with certain disclosed embodiments. Further, the steps described are not intended to be exhaustive or absolute, and various steps can be inserted or removed.

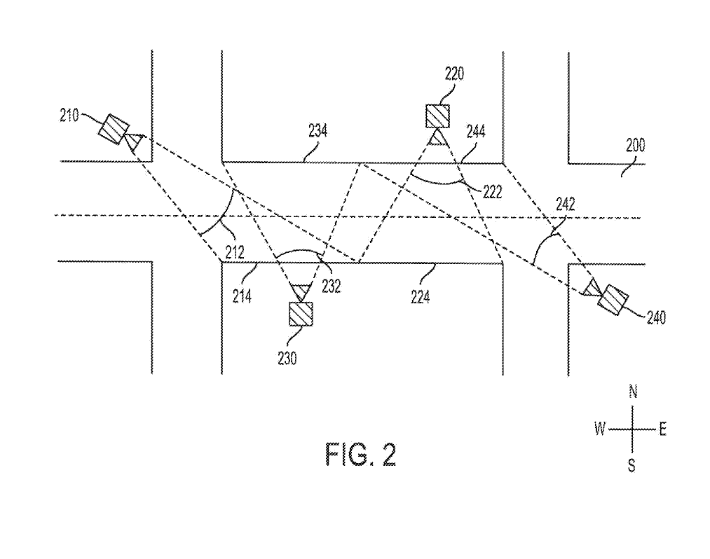

FIG. 2 is a diagram depicting an exemplary video camera arrangement for determining parking occupancy of a parking area, consistent with certain disclosed embodiments. FIG. 2 is intended merely for the purpose of illustration and is not intended to be limiting.

As depicted in FIG. 2, video camera video camera 220, video camera 230, and video camera 240 can be positioned to record video of a particular parking area. In this example, the parking area monitored by the video cameras can be a parking area corresponding to a city block along street 200. In other embodiments, monitored parking areas can be larger or smaller than a city block, and disclosed embodiments are not limited to street parking.

Camera view 212 can represent a view of video camera 210, and can show that video camera 210 is monitoring the southwest portion 214 of street 200. Camera view 222 can represent a view of video camera 220, and can show that video camera 220 is monitoring the southeast portion 224 of street 200. Camera view 232 can represent a view of video camera 230, and can show that video camera 230 is monitoring the northwest portion 234 of street 200. Camera view 242 can represent a view of video camera 240, and can show that video camera 240 is monitoring the northeast portion 244 of street 200.

Accordingly, video camera 210, video camera 220, video camera 230, and video camera 240 can monitor one whole block of street 200. Additionally, in embodiments, video camera 210, video camera 220, video camera 230, and video camera 240 can all transmit video data to a single computing device. As discussed above, the computing device can process the video data to determine parking occupancy data for the parking area, generate textual data corresponding to the parking occupancy data, and transmit the textual data to a central server. The central server may maintain and aggregate records for a much larger area, such as an entire city, and can respond to requests for parking occupancy data from users.

In the example depicted in FIG. 2, the camera views of the video cameras are shown to monitor separate sections of a parking area. However, in other embodiments, the video cameras may be positioned to have larger overlap between camera views to, for example, mitigate occlusion factors, provide multiple sets of video data to mitigate video processing errors, etc.

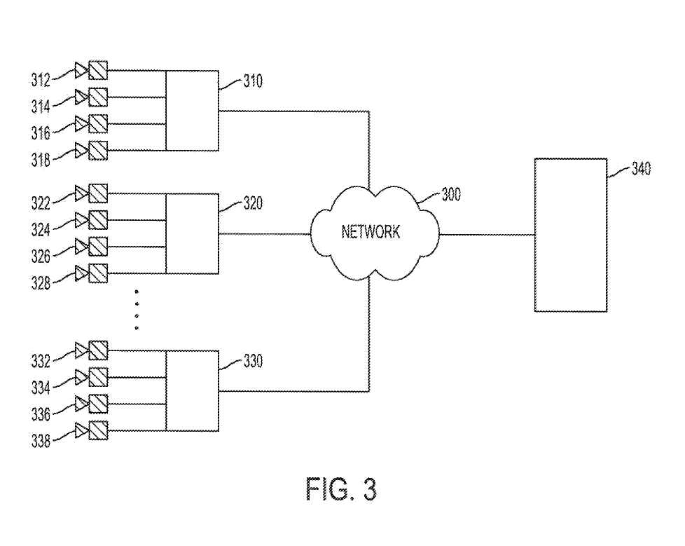

FIG. 3 is a diagram depicting an exemplary parking monitoring network, consistent with certain disclosed embodiments. FIG. 3 is intended merely for the purpose of illustrating a partially wired parking monitoring network system and is not intended to be limiting.

As depicted in FIG. 3, computing device 310, computing device 320, and computing device 330 can be connected to network 300. In embodiments, network 300 can be the internet. Additional computing devices can be connected to network 300, consistent with certain disclosed embodiments.

Video cameras 312, 314, 316, and 318 can be connected to computing device 310. Video cameras 322, 324, 326, and 328 can be connected to computing device 320. Video cameras 332, 334, 336, and 338 can be connected to computing device 330. In embodiments, the video cameras can be directly connected to the computing devices, can be indirectly connected to the computing devices (e.g. using one or more switches and/or routers), or a combination thereof.

Accordingly, each video camera can transmit video data to its respective computing device. Each computing device can process the video data to determine parking occupancy data for the parking areas monitored by the attached video cameras, and each computing device can generate textual data corresponding to the parking occupancy data.

Central server 340 can additionally be connected to network 300. Accordingly, computing device 310, computing device 320, computing device 330, and any additional computing devices in the parking monitoring network can transmit textual data corresponding to parking occupancy data to central server 340. Central server 340 can process the textual data from each computing device and maintain a database of real-time parking occupancy data across an area monitored by all video cameras in the parking monitoring network. Further, central server 340 can generate parking occupancy reports, manage parking space payments, and/or receive and respond to requests for parking occupancy status information for any parking area monitored as part of the parking monitoring network.

The diagram depicted in FIG. 3 is not intended to be limiting, and a parking monitoring network can include more or less computing devices, and the computing devices can be connected to more or less video cameras. Further, other parking monitoring networks may include more than one network and/or more than one central server, consistent with certain disclosed embodiments.

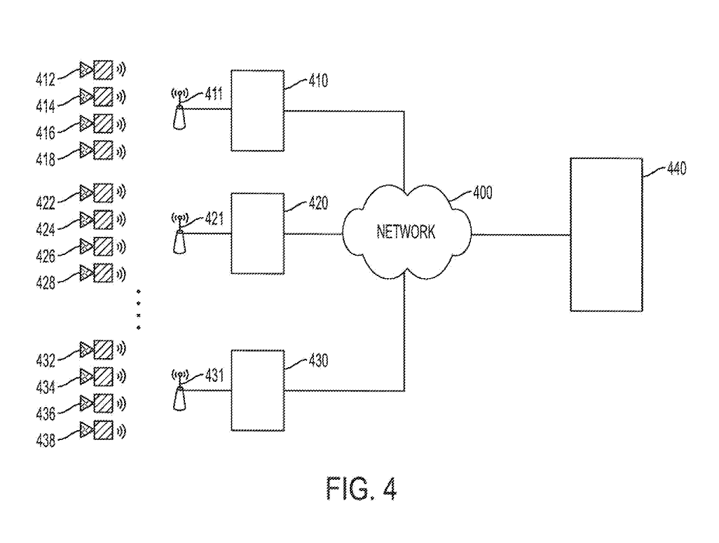

FIG. 4 is a diagram depicting an exemplary parking monitoring network, consistent with certain disclosed embodiments. FIG. 4 is intended merely for the purpose of illustrating a partially wireless parking monitoring network system and is not intended to be limiting.

As depicted in FIG. 4, computing device 410, computing device 420, and computing device 430 can be connected to network 400. In embodiments, network 400 can be the internet. Additional computing devices can be connected to network 400, consistent with certain disclosed embodiments.

Video cameras 412, 414, 416, and 418 can transmit signals to computing device 410 via wireless access point 411. Video cameras 422, 424, 426, and 428 can transmit signals to computing device 420 via wireless access point 421. Video cameras 432, 434, 436, and 438 can transmit signals to computing device 430 via wireless access point 431. Although wireless access points 411, 421, and 431 are depicted in FIG. 4 as separate from computing devices 410, 420, and 430, respectively, the wireless access points can, in further embodiments, be part of the computing device.

Accordingly, each video camera can transmit video data to its respective computing device. Each computing device can process the video data to determine parking occupancy data for the parking areas monitored by the attached video cameras, and each computing device can generate textual data corresponding to the parking occupancy data.

Central server 440 can additionally be connected to network 400. Accordingly, computing device 410, computing device 420, computing device 430, and any additional computing devices in the parking monitoring network can transmit textual data corresponding to parking occupancy data to central server 440. Central server 440 can process the textual data from each computing device and maintain a database of real-time parking occupancy data across an area monitored by all video cameras in the parking monitoring network. Further, central server 440 can generate parking occupancy reports, manage parking space payments, and/or receive and respond to requests for parking occupancy status information for any parking area monitored by the parking monitoring network.

The diagram depicted in FIG. 4 is not intended to be limiting, and a parking monitoring network can include more or less computing devices, and the computing devices can be connected to more or less video cameras. Further, other parking monitoring networks may include more than one network and/or more than one central server, consistent with certain disclosed embodiments. Additionally, in certain embodiments, a parking monitoring network can utilize a combination of wireless and wired components. For example, a first computing device can be wired to its respective video cameras, a second computing device can communicate with its respective video cameras via wireless signal, and a third computing device can use a combination of wired and wireless connections, consistent with certain disclosed embodiments.

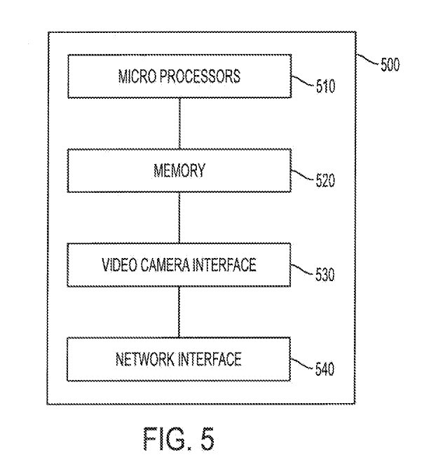

FIG. 5 is a diagram illustrating an exemplary hardware system for determining parking occupancy, consistent with certain disclosed embodiments. Computing device 500 may represent any type of one or more computing devices. For example, computing device 500 may represent computing devices 310, 320, and 330 in FIG. 3, computing devices 410, 420, and 420 in FIG. 4, etc.

Computing device 500 may include, for example, one or more microprocessors 510 of varying core configurations and clock frequencies; one or more devices or computer-readable media 520 of varying physical dimensions and storage capacities, such as flash drives, hard drives, random access memory, etc., for storing data, such as images, files, and program instructions for execution by one or more microprocessors 510; one or more transmitters for communicating over network protocols using network interface 540, such as Ethernet, code divisional multiple access (CDMA), time division multiple access (TDMA); etc. One or more microprocessors 510, one or more memory devices or computer-readable media 520, and network interface 540 may be part of a single device as disclosed in FIG. 5 or may be contained within multiple devices. Those skilled in the art will appreciate that the above-described componentry is exemplary only, as computing device 500 may comprise any type of hardware componentry, including any necessary accompanying firmware or software, for performing the disclosed, embodiments. Further, computing device 500 can include, for example, video camera interface 530 for communication with one or more video cameras.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments. The step described need not be performed in the same sequence discussed or with the same degree of separation. Likewise, various steps may be omitted, repeated, or combined, as necessary, to achieve the same or similar objectives or enhancements. Accordingly, the present disclosure not limited to the above-described embodiments, but instead is defined by the appended claims in light of their full scope of equivalents.

What is claimed is:

1. A system for determining parking occupancy, the system comprising:
a plurality of video cameras;
a processing system comprising one or more processors capable of receiving data from the plurality of video cameras; and
a memory system comprising one or more computer-readable media, wherein the one or more computer-readable media contain instructions that, when executed by the processing system, cause the processing system to perform operations comprising:
receiving video data for a parking area from the plurality of video cameras;
determining parking occupancy data for the parking area using the video data for the parking area;
generating textual data corresponding to the parking occupancy data for the parking area; and
transmitting the textual data corresponding to the parking occupancy data for the parking area to a central server.

2. The system of claim 1, wherein the textual data comprises an estimated number of available parking spaces for the parking area.

3. The system of claim 1, wherein the textual data comprises vehicle identifications.

4. The system of claim 1, wherein the textual data comprises identified parking violations.

5. The system of claim 1, wherein the textual data comprises parking space availability information for each parking space in the parking area.

6. The system of claim 1, wherein:
transmitting the textual data comprises transmitting the textual data from a computing device comprising the processing system; and
the central server receives textual data from a plurality of computing devices.

7. The system of claim 6, wherein the central server:
maintains a database of parking occupancy data; and
is configured to respond to requests for parking occupancy information based on the parking occupancy data.

8. A method for determining parking occupancy, the method comprising:
receiving video data for a parking area from a plurality of video cameras;
determining, using one or more processors, parking occupancy data for the parking area using the video data for the parking area;
generating textual data corresponding to the parking occupancy data for the parking area; and
transmitting the textual data corresponding to the parking occupancy data for the parking area to a central server.

9. The method of claim 8, wherein the textual data comprises a number of available parking spaces in the parking area.

10. The method of claim 8, wherein the textual data comprises vehicle identifications.

11. The method of claim 8, wherein the textual data comprises identified parking violations.

12. The method of claim 8, wherein the textual data comprises parking space occupancy status information for each parking space in the parking area.

13. The method of claim 8, wherein:
transmitting the textual data comprises transmitting the textual data from a computing device comprising the one or more processors; and
the central server receives textual data from a plurality of computing devices.

14. The method of claim 13, wherein the central server:
maintains a database of parking occupancy data; and
is configured to respond to requests for parking occupancy information based on the parking occupancy data.

15. A method of maintaining a database of parking occupancy data, the method comprising:
receiving, from a plurality of computing devices, textual data corresponding to parking occupancy data, wherein:
each of the plurality of computing devices receives video data from a plurality of video cameras; and
the textual data is generated by the plurality of computing devices based on the video data;
parsing the textual data to determine the parking occupancy data; and
updating the database of parking occupancy data based on the parking occupancy data using one or more processors.

16. The method of claim 15, wherein the textual data comprises an estimated number of available parking spaces for the parking area.

17. The method of claim 15, wherein the textual data comprises vehicle identifications.

18. The method of claim 15, wherein the textual data comprises identified parking violations.

19. The method of claim 15, wherein the textual data comprises parking space occupancy status information for each parking space in the parking area.

20. The method of claim 15, further comprises:
receiving a request for parking occupancy information related to one or ore parking areas;
searching the database of parking occupancy data for the parking occupancy information; and
transmitting a response to the request based on the parking occupancy information.
